(19) United States
(12) Patent Application Publication
(10) Pub. No.: US 2008/0187164 A1
(43) Pub. Date: Aug. 7, 2008

(54) Anti-Falling Casing Device For Wired Single-Ear Headset

(76) Inventor: Ching-Tsai Chou, Tai-Chong Hsien (TW)

Correspondence Address: LIN & ASSOCIATES INTELLECTUAL PROPERTY, INC., P.O. BOX 2339, SARATOGA, CA, 95070-0339, US

(21) Appl. No.: 11/671,465

(22) Filed: Feb. 6, 2007

(51) Int. Cl. H04R 1/10

(52) U.S. Cl. 381/381

(57) ABSTRACT

The casing device provides at least a fastening element arranged on the outer surface of the main member of a wired single-ear headset. At least one of the fastening elements should be located above the cable opening on the main member. As such, by fixing the signal cable in one or more of the fastening elements, the signal cable is redirected upward and extended along the main member to stride over a user's ear and then hang down to connect to a mobile phone or PDA.

### BACKGROUND OF THE INVENTION

1. Field of the Invention

The present invention generally relates to wired single-ear headsets, and more particularly to a casing device for securing a wired single-ear headset on a user's ear.

2. The Prior Arts

Headsets have been a device commonly found in daily life. However, promoted by the widespread popularity of mobile consumer electronic devices such as cellular phones, MP3 players, and PDAs, headsets have become not only a necessary accessory to these mobile devices but also a fashionable object.

A type of headsets quite popular recently is the so-called wired single-ear headset as shown in FIGS. 1a and 1b. As illustrated in FIG. 1a, the casing device for this type of headsets usually contains an arc-shaped suspension member 20 attached to a main member 10 of the device for hanging on a user's left or right ear. Another type of sing-ear headset has a plug member (not visible in the drawing) extended from the main member 10 for plugging into the helix of an ear. How this type of single-ear headsets is worn is schematically shown in FIG. 1b. The connection of the wired single-ear headset to the mobile phone or PDA is established by a signal cable 30 extended from the circuit housed inside the main member 10 through an opening on the inner side or bottom side of the main member 10. In this specification, all directional references are made relatively to the headset when it is properly worn on a user's ear. For example, the side closer to the user's face is referred to as the inner side and the opposite side is therefore referred to as the outer side.

The wired single-ear headset is quite popular due to its lower price tag compared to the wireless ones. However, a significant disadvantage of the wired single-ear headset is that it would easily fall off from the user's ear when the signal cable is tangled with some body part or an external object. In the worst case, the wired single-ear headset therefore drops to the ground and damaged. Currently, there is no solution that can achieve an ideal balance between wearing comfort and steadiness.

### SUMMARY OF THE INVENTION

Therefore, the present invention provides a casing device for wired single-ear headset which innovatively utilizes the signal cable to prevent the headset from falling off when the signal cable itself is pulled or twitched.

The casing device provides at least a fastening element arranged on the outer surface of the main member. The height (relative to the ground) of the fastening element is higher than the opening on the main member through which the signal cable is extended through (hereinafter, the cable opening). When multiple fastening elements are configured, at least one of them should be above the cable opening on the main member. As such, by fixing the signal cable in the one or more fastening elements, the signal cable is directed upward and extended along the main member to stride over a user's ear and then hang down to connect to the mobile phone or PDA. As the signal cable is soft and flexible, it exerts very little or no burden to the ear. When the signal cable is caught or pulled, the ear will effectively prevent or block the force from pulling down the wired single-ear headset.

Another embodiment of the present invention is to provide at least a plug hole on the main member which is above the cable opening. When there are more than one plug hole, at least one of them should be above the cable opening. On the other hand, at least a small and soft pin is provided at appropriate places along the signal cable. As such, the signal cable can be fixed by plugging the pins of the signal cable into the plug holes of the main member respectively and, thereby, the signal cable is directed upward and extended along the main member to stride over a user's ear and then hang down to connect to the mobile phone or PDA.

The foregoing and other objects, features, aspects and advantages of the present invention will become better understood from a careful reading of a detailed description provided herein below with appropriate reference to the accompanying drawings.

### BRIEF DESCRIPTION OF THE DRAWINGS

FIGS. 1a and 1b are side views showing two conventional wired single-ear headsets.

FIGS. 2a and 2b are side and top views of a wired single-ear headset according to a first embodiment of the present invention.

FIG. 2c is a perspective view showing how the signal cable is redirected by a number of fastening elements according to the first embodiment of the present invention.

FIG. 2d is a perspective view showing how the signal cable is redirected by a number of fastening elements according to a second embodiment of the present invention.

### DETAILED DESCRIPTION OF THE PREFERRED EMBODIMENTS

The following descriptions are exemplary embodiments only, and are not intended to limit the scope, applicability or configuration of the invention in any way. Rather, the following description provides a convenient illustration for implementing exemplary embodiments of the invention. Various changes to the described embodiments may be made in the function and arrangement of the elements described without departing from the scope of the invention as set forth in the appended claims.

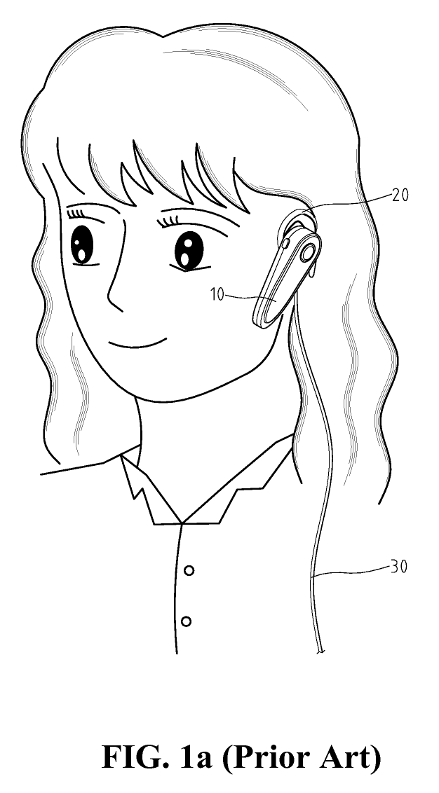

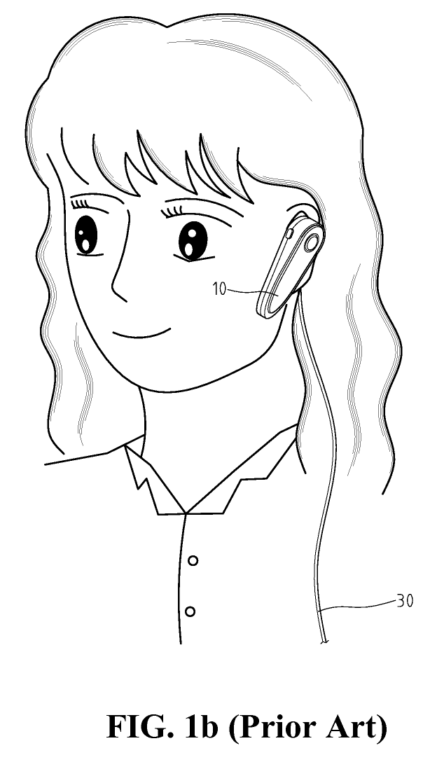

The casing device provided by the present invention can be applied to basically all sorts of wired single-ear headsets which contain at least an earphone and a microphone. There is no specific requirement on the appearance, form factor, or the technology used for the headset (e.g., the microphone could be a condenser or piezoelectric microphone). Abstractly, the casing device of any wired single-ear headset, as illustrated in FIGS. 1a and 1b, should have a main member 10, a suspension or plug member 20, hereinafter a fixation member (not visible in FIG. 1b), attached to the main member 10 for fixing the headset on a user's left or right ear, and a signal cable 30 extended from the circuit inside the main member 10 and through an opening at an appropriate place of the main member 10. Furthermore, the main member 10, regardless of its appearance, should have two ends: the one having the earphone embedded is higher above the other for attaching to or plugging into the ear canal; and the other one having the microphone embedded is lower for attaching to the cheek or for being in the proximity of the mouth. The signal cable 30 is usually, as illustrated, hangs down from the inner or outer side of the main member 10, as illustrated in the drawings. In the following, the wired single-ear headset as shown in FIG. 1b is used as an example in explaining a number of embodiments of the present invention.

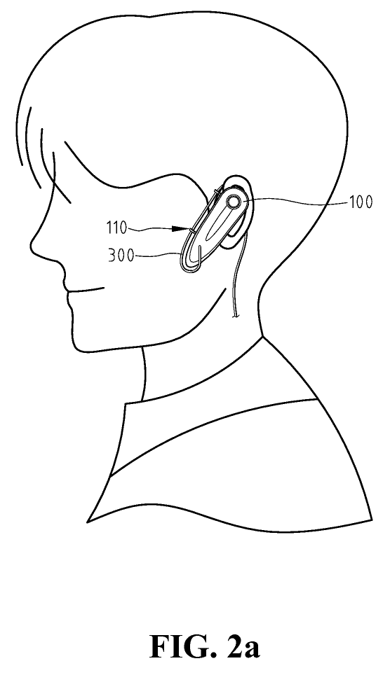

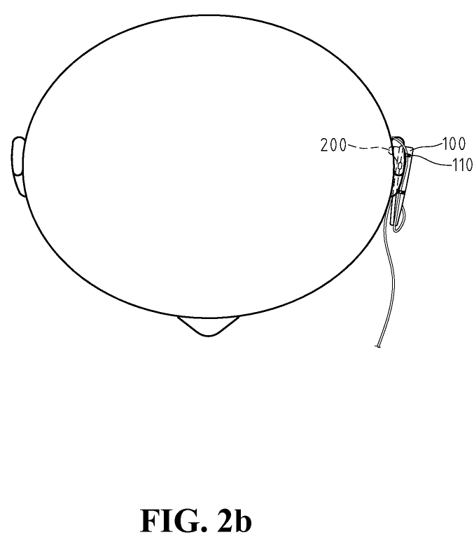

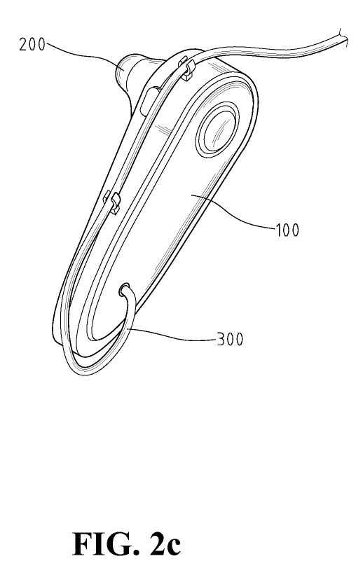

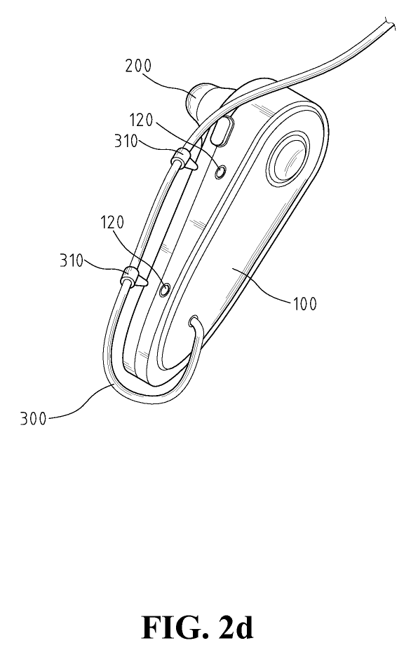

FIGS. 2a and 2b are side and top views of a wired single-ear headset according to a first embodiment of the present invention. As illustrated, a fixation member 200 is attached to a main member 100 for embedding into the helix of a user's ear. On the other hand, a signal cable 300 is extended from the circuit housed inside the main member 100 and through an opening of the main member 100 (i.e., cable opening). Also on the main member 100 and at the same side as the fixation member 200, there is a plug-like earphone for insertion into the ear canal but, for simplicity, the earphone is not depicted in the drawings. The main member 100 has at least a fastening element extended outward from the main member 100. In this embodiment, the fastening element is a C-shaped clip 110 substantially perpendicular to the main member 100. The fastening element is made of a flexible material such as rubber and it can be integrally formed with the main member 100 or it can be separately formed and then attached or adhered to the main member 100 later. The breach of the C-shaped clip 110 can face upward, inward, or outward, and is slightly smaller than the diameter of the signal cable 300 so that, due to the flexibility of the material used, the signal cable 300 can be squeezed into (thereby, clipped by) the through hole of the C-shaped clip 110. The aperture of the through hole of the C-shaped clip 110 is identical to or slightly larger than the diameter of the signal cable 300 so as to allow the signal cable 300 to pass through. Even though it is referred to as having a C-like shape, the through hole can have a circular, rectangular, or other appropriate shape as long as the signal cable 300 can be accommodated. FIG. 2c is a perspective view showing how the signal cable 300 passes through the fastening element 110. Please note that the present invention does not place specific requirement on the fixation member 200 and the signal cable 300. In addition, the cable opening of the main member 100 which the signal cable 300 passes through is not limited to be on the outer side of the main member 100 as shown in the drawing; the opening can also be provided on the inner side, bottom side, or any other appropriate place.

The clip 110 has to be located so that its height (relative to the ground after the headset is properly worn) is greater than that of the cable opening of the main member 100. When there are multiple clips 110, at least one of them has to be located above the cable opening. In addition, the clip or clips 100 have to be appropriately arranged so that, after the signal cable 300 is fixed by the clip or clips, the originally hanging-down signal cable 300 is redirected to run upward along the main member 100, stride over the ear, and then hang down to connect to the cellular phone or PDA. As the signal cable 300 is flexible and soft, hanging over the ear will not give noticeable burden to the ear. When the cellular phone or PDA is pulled, or the signal cable 300 is caught by some external object and twitched, the pulling force along the signal cable 300 is buffered, shared, or blocked by the ear and, therefore, the headset wouldn't easily fall off.

Another embodiment of the present invention is to provide at least a socket such as a plug hole 120 on the main member 100 and, correspondingly, at least a plugging element such as a small and soft pin 310 is provided at places along the signal cable 300. The pin or pins 310, made of a flexible material such as rubber, can be integrally formed with the signal cable 300 or they are separately formed and adhered to the signal cable 300 later. The aperture, shape, and depth of the plug hole 120 are compatible with the diameter, shape, and length of the pin 310 so that the pin 310 can be plugged tightly into the plug hole 120, as shown in FIG. 2d. The number of pins 310 and the number of plug holes 120 can be identical or different.

The provision of the plug holes 120 should follow the same constraint as the C-shaped clips 110 in the previous embodiment. More specifically, the plug hole 120 should have a height (relative to the ground after the headset is properly worn) greater than that of the cable opening of the main member 100 when the headset is properly worn. When there are multiple plug holes 120, at least one of them should be above the cable opening. In addition, the plug holes 120 have to be appropriately arranged so that, after the signal cable 300 is fixed by plugging the pin or pins 310 into one or more plug holes 120, the originally hanging-down signal cable 300 is redirected to run upward along the main member 100, stride over the ear, and then hang down to connect to the cellular phone or PDA. As the signal cable 300 is flexible and soft, the signal cable 300's hanging over the ear will not give noticeable burden to the ear. When the cellular phone or PDA is pulled, or the signal cable 300 is caught by some external object and twitched, the pulling force along the signal cable 300 is buffered, shared, or blocked by the ear and, therefore, the headset wouldn't easily fall off.

Please note that the foregoing two embodiments can be jointly implemented in a single wired single-ear headset. In other words, the pins 310, plug holes 120, and clips 110 are used together to fix the signal cable 300 along the main member 100. On the other hand, as some single-ear headset can be worn on either left or right ear, the top side of the headset on one ear could become the bottom side when worn on the other ear. For these headsets, the plug holes 120 or the clips 110 are arranged on both sides of the headsets so that the anti-falling function is still preserved when the headset is switched from one ear to the other ear.

Although the present invention has been described with reference to the preferred embodiments, it will be understood that the invention is not limited to the details described thereof. Various substitutions and modifications have been suggested in the foregoing description, and others will occur to those of ordinary skill in the art. Therefore, all such substitutions and modifications are intended to be embraced within the scope of the invention as defined in the appended claims.

What is claimed is:

1. A casing device for a wired single-ear headset comprising:
a main member housing a circuit of said headset, said circuit connected to an electronic device by a signal cable passing through a cable opening of said main member;
a fastening element extended outward from the surface of said main member; and
a fixation member attached to said main member for positioning said main member on a user's ear;
wherein said fastening element is located above said cable opening when said main member is worn on said user's ear; and, by fixing said signal cable by said fastening element, said signal cable is redirected to stride over said user's ear and hang down to connect to said electronic device.

2. The casing device according to claim 1, wherein said fastening element is a C-shaped clip made of a flexible material; a breach of said C-shaped clip is slightly smaller than the diameter of said signal cable; said breach allows said signal cable to be squeezed into a through hole of said C-shaped clip; said through hole of said C-shaped clip allows said signal cable to pass through.

3. A casing device for a wired single-ear headset comprising:
a main member housing a circuit of said headset, said circuit connected to an electronic device by a signal cable passing through a cable opening of said main member, said main member having a socket on the surface of said main member;
a plugging element positioned along said signal cable between said cable opening and said electronic device; and
a fixation member attached to said main member for positioning said main member on a user's ear;
wherein said socket is located above said cable opening when said main member is worn on said user's ear; and, by plugging said plugging element into said socket, said signal cable is redirected to stride over said user's ear and hang down to connect to said electronic device.

4. The casing device according to claim 3, wherein said socket is a plug hole; and said plugging element is a pin made of a flexible material.
